(19) United States
(12) Patent Application Publication
(10) Pub. No.: US 2005/0086158 A1
(43) Pub. Date: Apr. 21, 2005

(54) House tour guide system

(76) Inventor: Timothy P. Clare, Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/970,146

(22) Filed: Oct. 21, 2004

Related U.S. Application Data
(60) Provisional application No. 60/513,084, filed on Oct. 21, 2003.

(51) Int. Cl. G06F 17/60

(52) U.S. Cl. 705/38

(57) ABSTRACT

The invention is a system for an automated house tour guide that improves the exchange of information between a seller and a prospective buyer, where that information is normally only available through a combination of pictures and datasheets of a house, a number of public databases, an informed real estate agency, and a seller of the house. The invention merges these sources and puts them at the fingertips of the prospective buyer so that the buyer can take a self-directed tour of the house, or in the company of an agent of the buyer, or in the company of the seller. The system is composed of a portable computerized communication device having a graphic user interface with a touch-screen, a speaker, and a means for loading data to the device; a database software application that contains a script that provides information about the corresponding house; and a proximity/motion sensor. The motion sensor can be disabled, as appropriate. The portable computerized communication device can furthermore operate wirelessly, thereby opening up access to the Internet, cell phones, the PSTN, contact with a real estate home office computer network. The system can be configured for use by the seller or an agent of the seller to provide information during an open house, or configured for use by the prospective buyer, or an agent of a buyer to conduct a tour of houses. The script, in addition to describing the house on a room-by-room basis, also typically has information on amenities, the community, financial data, age and environmental data, the start time for an open house, the end time for the open house, and other information that may be of interest to the prospective buyer.

### CROSS-REFERENCE TO RELATED APPLICATION

This application claims the benefit of the priority filing date of U.S. Provisional Patent Application Ser. No. 60/513,084 entitled HOUSE TOUR GUIDE SYSTEM filed on Oct. 21, 2003, by the same inventor.

### BACKGROUND OF THE INVENTION

1. Field of the Invention

The present invention relates to a method and system that facilitates the sale, rental and leasing of commercial or residential real estate buildings. Exemplary of systems that are used in the merchandizing of real estate is the system of securing a house with a lockbox. The lockbox limits access to the interior of the premises to professional real estate personnel and their clients. The invention more particularly is a method and a system that can be used by sellers and their agents that enables a prospective buyer or other client to take a self-directed tour of the house. The invention can be used to provide extensive information about the real estate during an actual tour of the property. The invention furthermore is a method and a system that can be used by real estate agents and their prospective buyers to plan and execute tours of real estate.

2. Prior Art

There are substantially two scenarios of an actual real estate tour. In the most common scenario, the tour is conducted by the buyer's agent, who in most cases has never met the seller, and may or may not, be familiar with the property. If the buyer's agent is familiar with the property it's largely from information gathered by the seller's agent following a scripted series of questions, that are designed to meet the minimum requirements by law. The information gathered by the seller's agent tends to be general in nature, except for questions that specifically address potential environmental and health issues. For instance, the description of the property usually includes the total number of square feet, the year the house was built, the number of rooms, age of the roof, age of heating and air conditioning, veneer, number of rooms and baths, the style of the house (i.e. Cape Code), and maybe the type of flooring. In most cases, the information that is provided is not room-specific. For instance, specific information would include that the master bedroom has 300 sq. ft., hardwood floors, 50 ft. of closet space, ten electrical receptacles, four of which are controlled by switches, double-pane xenon filled Anderson windows having an energy rating of −9 W/m², remote controlled ceiling fans, fireplace with partially vented gas fireplace logs with electronic switch ignition, carbon monoxide and smoke detectors, intercom, installed vacuum system, and thermostatic control of the room. While it is not out of the realm of the possibility that the buyer's agent may be familiar with all of the features of the house, it is highly improbable. Many of these features may not even be on the shopping list of requirements for the buyer, however, the features might be highly desirous if made aware of them. When the buyer and the buyer's agent tour the house, most of the gross features will become readily apparent, for instance, the floors, the type of doors, the colors of the ceiling, and whether there is a ceiling fan. However, many of the amenities will not be observed during the course of a typical tour unless they are specifically pointed out. The reason for the oversight is that certain amenities are not easily observable with just a routine perusal of a room. The second type of tour is a tour provided by the seller's agent. Typically, these tours are termed open-houses, wherein between a span of several hours prospective buyers are free to walk through the house, typically unescorted by the seller's agent. Touring an open-house with the seller's agent may, in fact, result in a slightly more comprehensive list of information than with a buyer's agent. However, in most cases the seller's agent frequently is engaged in multiple conversations that are largely repetitious and short on detail.

A third type of tour is a virtual tour, wherein the prospective buyer, either over the Internet or at a real estate office, can quickly view pictures of an array of homes. Typically, these pictures are digital images that are stored in a database, along with a set of criteria about the house, such as location, size, cost, style, age, veneer, features, MLS number. From the pictures and the criteria the prospective buyer can develop a list of homes that they would actually like to see in person.

What is needed is a system that integrates a virtual tour with an actual tour, therein providing the prospective buyer with more information during the actual tour. The system should preferably unobtrusively provide detailed information about the property as it is being toured, where the information is delivered in an esthetically pleasing, largely automated fashion, wherein at the discretion of the user (e.g., the prospective buyer or the real estate agent), detailed information is available literally at their fingertips.

### SUMMARY OF THE INVENTION

The invention is a system for an automated house tour guide that improves the exchange of information between a seller and a prospective buyer, where that information is normally only available through a combination of pictures and datasheets of a house, a number of public databases, an informed real estate agency, and a seller of the house. The invention merges these sources and puts them at the fingertips of the prospective buyer so that the buyer can take a self-directed tour of the house, or in the company of an agent of the buyer, or in the company the seller. The system is comprised of a portable computerized communication device having a graphic user interface, a speaker, a touch-screen, and a means for loading data to the device; a database software application that contains a script that provides information about the corresponding house; and a proximity/motion sensor. The motion sensor can be disabled, as appropriate. The portable computerized communication device can furthermore be comprised of means for communicating wirelessly, thereby opening up access to the Internet, cell phones, the PSTN, contact with a real estate home office computer network. The system can be configured for use by the seller, or an agent of the seller to provide information during an open house, or be configured for use by the prospective buyer or an agent of a buyer to conduct a tour of houses. The script, in addition to describing the house on a room-by-room basis, also typically has information on amenities, the community, financial data, age and environmental data, the start time for an open house, the end time for the open house, and other information that may be of interest to the prospective buyer.

The device has various selectable operating modes including an administrator guide mode, an explicit tour mode, an implicit tour mode, and a deferentially-explicit tour mode. The administrator guide mode is employed to download data relevant to one or more houses, and to configure control parameters of the device, such as when the device is tailored for an intended user. For instance, the administrator mode would be appropriate when a prospective buyer comes by the real estate office and develops a list of homes based on pictures and other criteria. The list is compiled and sorted so that the first house is the one closest to a desired geographic point, such as a school, a work address, or the distance from the prospective buyer's current address. The administrator mode can be used to select a preferred language for the script.

Typically, when the prospective buyer is leaving to visit the compiled list of houses, the mode is switched to the explicit tour mode, wherein touch-screens on the portable computerized communication device can be utilized by the intended user, such as the real estate agent or the prospective buyer, to access the data downloaded at the real estate office. When driving to a selected house, the touch-screen displays an address and, preferably, a picture of the outside of the house. The intended user explicitly controls the device through selections on the touch-screen, either by finger touch or a stylus. Upon entering the house, the user can select a screen that displays the floor plan of the house. When a point of the floor plan screen is touched, the device provides information on the room or area of the house that corresponds to the point on the floor plan screen. The information is provided as a script that can be generated texturally, or verbally, or both texturally and verbally. If there are two or more floors, preferably a screen illustrating each of the floors is available. If the house is so large as to be difficult to read the house plan screen, then the user can zoom in on a designated area for more detail and enlargement. The explicit mode also preferably has a screen, wherein the user can make notes to himself or can enter questions or comments that can be printed or emailed. The explicit mode also preferably has a screen, whereby the user can check off the house, and can select an option that indicates that the house may be worth a second tour. The explicit mode also preferably has a screen, wherein driving and or navigational instructions are displayed.

The portable computerized communication device can be used to augment an open house tour, and for this application the implicit tour mode is usually selected. In the implicit tour mode the motion sensor of the device is activated, and when a person enters a house or a room, the device implicitly knows to provide information about the room or house. Typically, the seller's agent or the seller would install the device in each of the rooms or areas where the device is going to provide information. Normally, in the implicit tour mode the house plan screen is locked or not visible during the open house, and the device provides information only about those areas that have been designated by the seller's agent or the seller who is conducting the open house. Optionally, during the open house the device can be set to the Notes screen, as previously described, so that a prospective buyer can leave a note for the seller or the seller's agent. The note is confidential, and can be left on the device, or transmitted by email to the appropriate party.

Alternatively, the device can be operated in the deferentially-explicit tour mode. In the deferentially-explicit tour mode, the motion sensor is initially activated upon sensing the proximity of someone entering the house to take a tour; the device prompts the prospective buyer to carry the device around for more detailed information. The deferentially-explicit tour mode is appropriate for either private tours or open-house tours, as this mode combines elements of both the explicit and the implicit tour mode. After the initial prompt, the motion sensor goes to a sleep mode, and the house plan touch screen is displayed, and the mode assumes most of the characteristics described for the explicit tour mode.

The system can also have a contract mode, wherein the device is configured to display a contract and accept money. Earnest money can be transferred electronically, either as a credit card or a debit card transaction, or as a digital signature on an account. The contract mode can be a stand-alone mode or appended to the administrator guide mode, the explicit tour mode, the implicit tour mode, and the deferentially-explicit tour mode.

The invention is a method for automating home tour guides. The method is composed of providing a portable computerized communication device with a graphic user interface having a touch-screen, a speaker, a digital image of a house plan, and a database software application that contains a script that provides information about the house; displaying a house plan on the screen; and touching the screen at a point in the house plan, thereby actuating the script to provide information about that point. In the administrator tour mode, the user selects a list of at least one house, either for a private tour or an open house, and downloads information specific to the house. The selected houses on the list can be sorted by criteria designated by the user, where examples of criteria include: ordering by distance from a designated starting point, ordering by size, ordering by cost, ordering by style of house, ordering by age, ordering by features. Depending on the intended use, the method an operating mode is selected. The operating modes are an explicit tour mode, wherein touch-screens on said device are selected by the intended user, such as a real estate agent or a client, to provide information; an implicit tour mode, wherein the motion sensor of said device detects an individual entering a house or a room, prompting said device to provide information about the room or house; and a deferentially-explicit tour mode, wherein said device, upon detecting an individual, announces to that individual, that said device is portable and can be carried on the tour to provide information about the house by activating the touch-screens. Selecting an operating mode imparts parameters. In the implicit tour mode, the motion sensor is actuated, and at least one of the devices is set up in a home or near an entrance of a room that is to be toured during an open-house or a private tour. Selecting the explicit tour mode provides the user a device he can use while on tour preloaded with a list of houses, information about each of the houses, and a means of taking notes and sending messages. Selecting the deferentially-explicit tour mode, initiates activation of the motion sensor, so that it can be used while touring an open house or while on a private tour, where the device is kept at the house to be used when viewing the house.

### BRIEF DESCRIPTION OF THE DRAWINGS

The foregoing and other objects will become more readily apparent by referring to the following detailed description and to the appended drawings.

FIG. 1 is a frontal view of a portable modular communication device illustrating a touch-screen displaying a list of houses to be visited.

FIG. 2 is a frontal view of a portable modular communication device illustrating a touch-screen displaying directions to the selected house to be toured.

FIG. 3 is a frontal view of a portable modular communication device illustrating a touch-screen displaying a view of a two-story house and data on property.

FIG. 4 is a frontal view of a portable modular communication device illustrating a touch-screen displaying a first floor plan of the house.

FIG. 5 is a frontal view of a portable modular communication device illustrating a touch-screen displaying a second floor plan of the house.

FIG. 6 is a frontal view of a portable modular communication device illustrating a touch-screen displaying notes, questions and comments made by the prospective buyer.

FIG. 7 is a frontal view of a portable modular communication device illustrating a touch-screen displaying the text of the script that is delivered.

FIG. 8 is a flow diagram of the method.

### DETAILED DESCRIPTION

The invention is a system 10 for an automated house tour guide that improves the exchange of information between a seller and a prospective buyer. The system is comprised of at least one portable computerized communication device 20 having a graphic user interface having a touch-screen, a speaker 16, a means for loading data to the device, a database software application that contains a script that provides information about a house, and a proximity /motion detector 18.

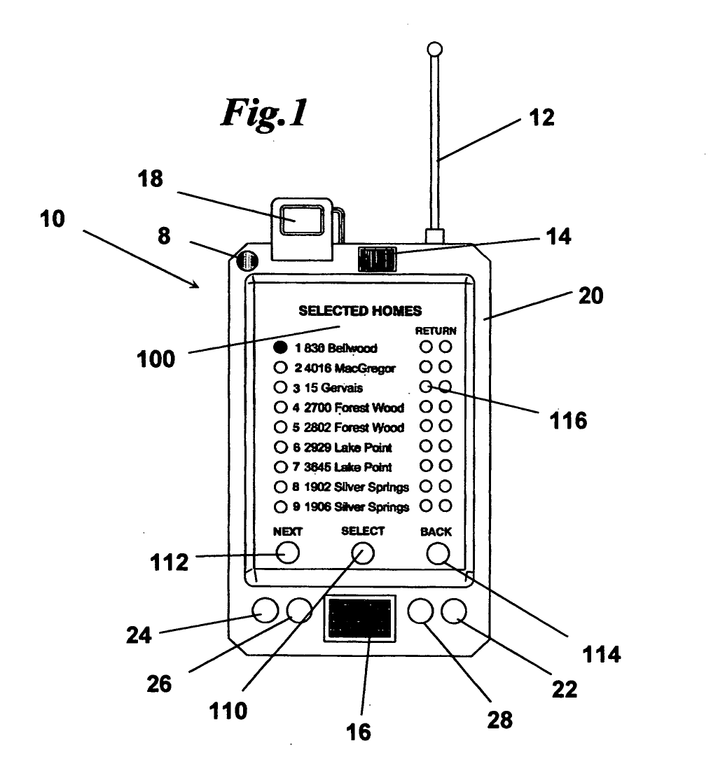

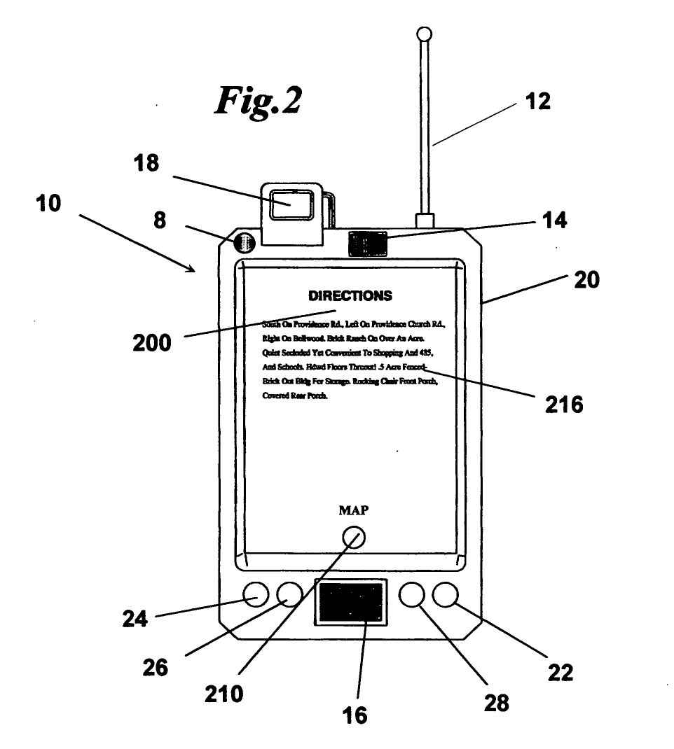

Referring to FIG. 1, the portable communication device 20, is a pocket personal computer (PPC), such as an HP® Ipaq 4700 or a Toshiba® Pocket PC e800. The PPC 20 has a wireless means 12 for communicating over the Internet and the public PSTN, a microphone 14, a data entry port (not shown), a video camera 8, a speaker 16, a volume control knob 28, a touch screen 116, a Next screen navigation button 22, a Previous screen navigation button 24, and Keyboard activation button 26. The motion detector 18 is connected to the PPC 20 through a USB port. The display 116 has a list of homes screen 100, designated by an address, that have been down loaded into the PPC 20. The list is sorted according to the distance from a designated location, such as work or a school. The list of homes screen 100 has an option button to the left of each address. The house can be selected by pressing the Select button 110, or by touching the address with a stylus (not shown). After a house has been selected, it changes color, indicating that it has been toured. To help the user keep track of whether they may want a follow up visit there is a Return column besides each address. In the illustrated List of homes screen 100 there are two Return columns. The user can also advance through the list of houses by using the Next button 112 or the Back button 114. Selecting an address brings up the Directions screen 200, as shown in FIG. 2. The directions 216 give driving instruction from the user's current location to the house to be toured. The current location can be automatically determined using a GPS navigational system, or down loaded at the real estate office, or via the Internet or other suitable system. The user can alternatively select a map 210 for directions.

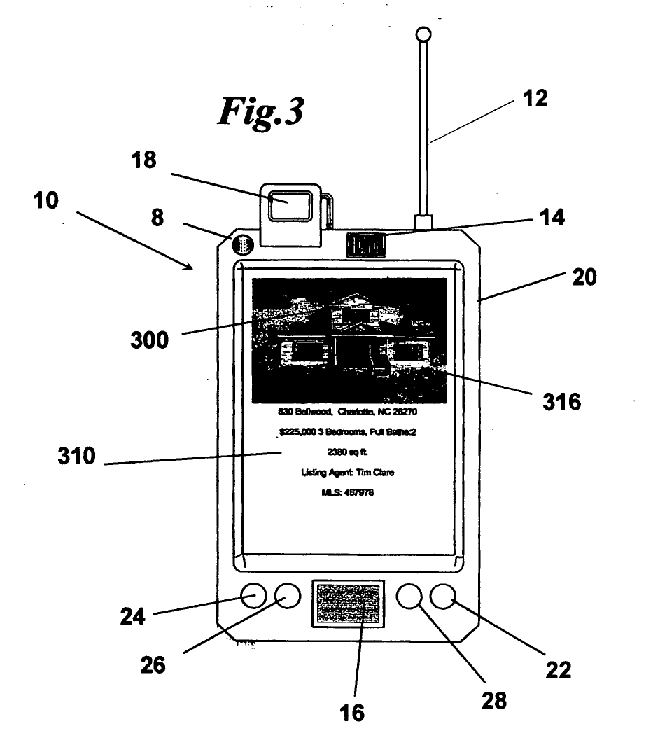

By advancing to the next screen by pressing Next button 24, the user brings up a Picture of the house screen 300. The Picture of the house screen 300, as shown in FIG. 3, displays a color picture of the house 316 to make road-side identification easier. Generalized information 310 is given under the picture 316. In the illustrated embodiment, the house is two stories.

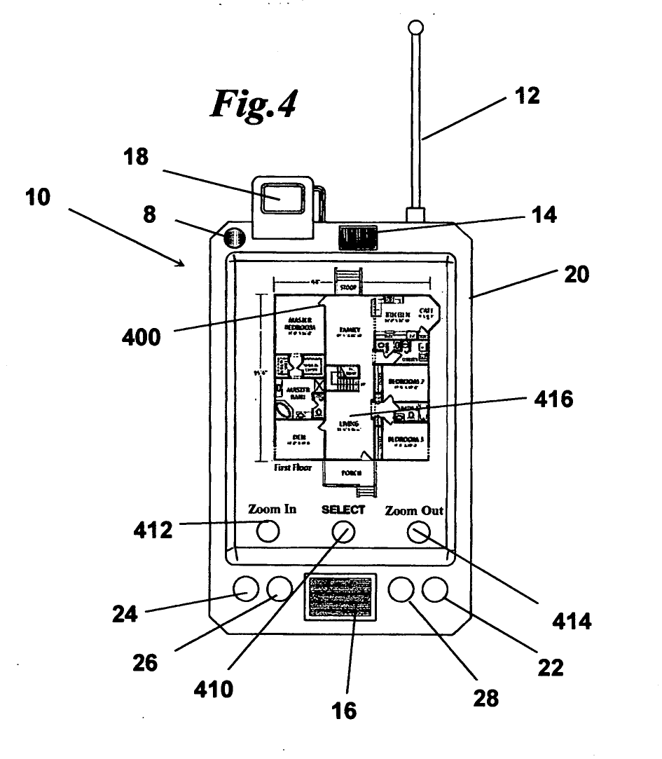

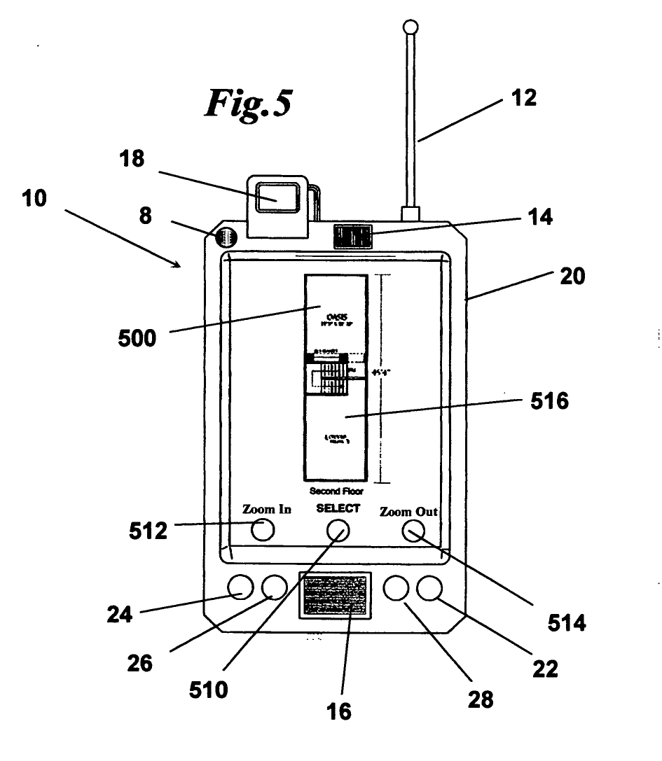

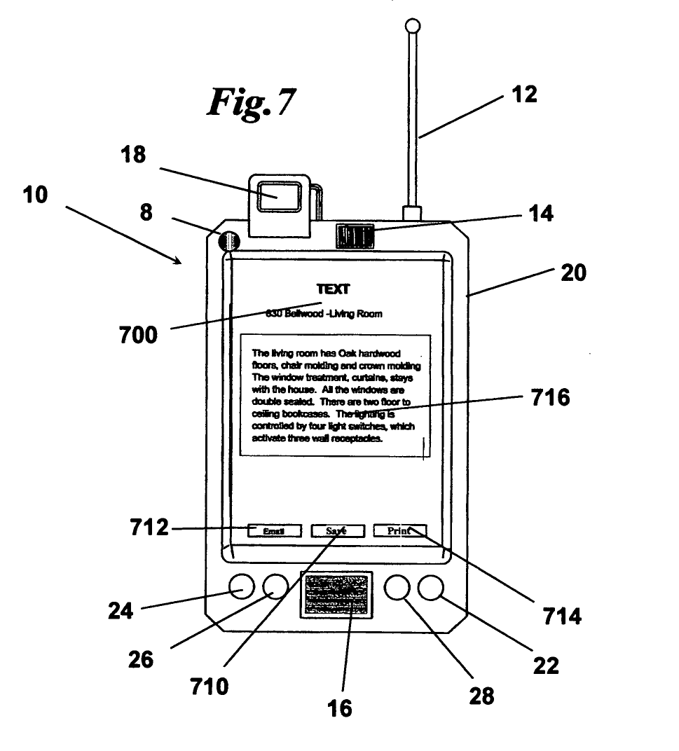

The user can advance to the next screen, the First floor house plan 400, as shown in FIG. 4, to access detailed information about the house while walking through the home. In FIG. 4 the arrow 416 is pointing to the living room. The script giving detailed information is initiated by either double tapping the touch-screen at the living room, or by touching the screen at the appropriate point and touching the Select button 410. The image of the floor plan 416 can be enlarged by pressing the Zooming In button 412, or reduced by pressing the Zooming Out button 414. The script 716, as shown in FIG. 7, is delivered verbally through speaker 16, in the language selected by the user. The script 716 is also viewable as text on the Text screen 700 as shown in FIG. 7. The Second floor house plan screen 500 is shown in FIG. 5. The image 516 can be touched to activate the script 716, as was described for the screen 400 in FIG. 4.

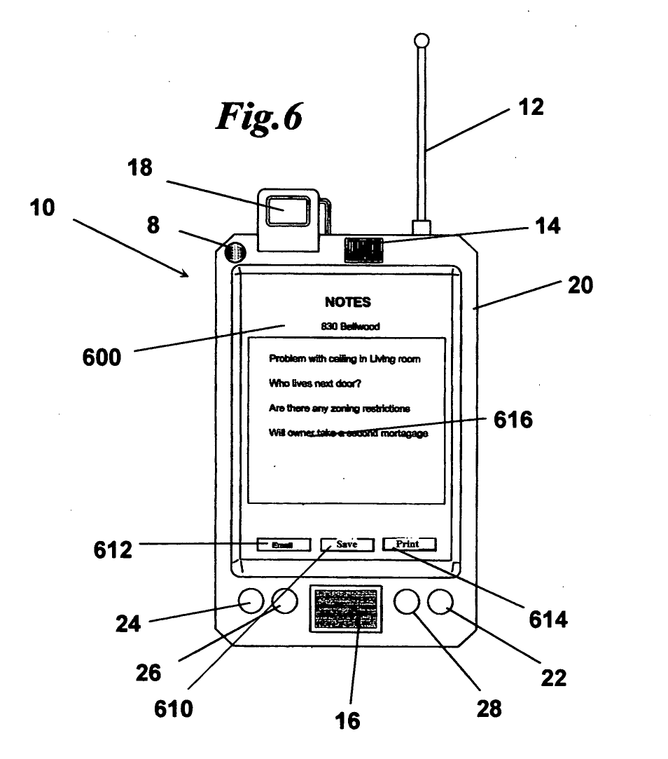

The user, at any time can advance to the Note 600 screen as shown in FIG. 6. The user makes notes 616 by writing with the stylus, recording through the microphone 14, or activating the keyboard 26. The system 10 automatically assigns the notes to the house address. In the Notes screen 600, the user can take pictures using the video camera 8; and the video images and the other notes 616 can be saved, emailed, or printed at a designated printer. For instance, the notes can be sent to the user's email address or printed out at the real estate office. The Notes screen 600 can be configured by the administrator to also accept a signed contract on the house, a digital signature, and to make financial transactions.

Returning to the Selected Homes screen 100, as shown in FIG. 1, the user can then select another house, which activates the Directions screen 200 to display direction on how to drive from the present house to the next house. The user can mark whether a return visit is needed. The tour can break off at any time and be resumed later, or the prospective buyer can return to the real estate office. The address list on the screen 100 can also have a feature that indicates that a prospective buyer has made an offer on the house, and that the price has changed, or that the owner of the house has lowered the price in order to speed up the sale.

The invention is a method for automating open house tour guides. The PPC 20 is preprogrammed to implicitly issue a welcoming script when the motion detector 18 senses that someone has entered the room. The device 20 then delivers a descriptive script 716 about the house or a designated area in the house.

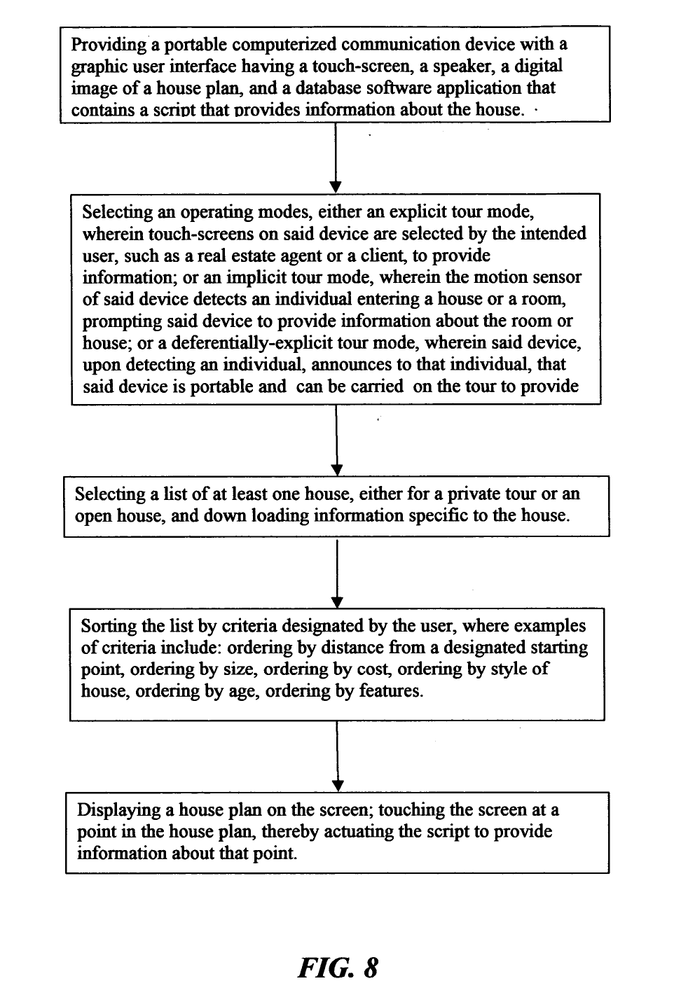

FIG. 8 diagrammatically illustrates the method for automating home tour guides. The method is comprised of: selecting a list of at least one house, either for a private tour or an open house, sorting the list by criteria designated by the user, where examples of criteria include: ordering by distance from a designated starting point, ordering by size, ordering by cost, ordering by style of house, ordering by age, ordering by features, or another specified criterion; providing a portable computerized communication device with a graphic user interface having a touch-screen, a speaker, a digital image of a house plan, and a database software application that contains a script that provides information about the house; displaying a house plan on the screen; and touching the screen at a point in the house plan, thereby actuating the script to provide information about that point.

In greater detail, the office on-site operating mode is the administrator tour mode, and the off-site operating tour modes are the implicit tour mode, the explicit tour mode, and the deferentially-explicit tour mode. The device is set to a mode in anticipation of who is the intended user. The implicit tour mode comprises initiating the activation of the motion sensor, and setting up at least one of the devices in a home or near an entrance of a room that is to be toured during an open-house or a private tour. The explicit mode comprises giving the intended user(s) the device to use while on tour. The deferentially-explicit tour mode comprises initiating the activation of the motion sensor, and setting up the device near the entrance of a home, wherein said device, upon detecting an individual, announces to that individual, that the computerized communication device is portable, and can be carried on the tour to provide information about the house by using the touch-screens.

In the specification and the appended claims, a “house” is defined as a generic term that is inclusive of forms of real estate property, such as commercial buildings, houses, apartments, home-site, farms, land, rental property, lease property, property being inspected, construction-sites and dwellings in-general.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

1. A system for an automated house tour guide, said system comprising:
a portable computerized communication device having a graphic user interface comprised of a touch-screen, a speaker, and a means for loading data to the device;
a database software application that contains a script that provides information about a house; and
a proximity /motion sensor.

2. The system, as claimed in claim 1, wherein the script describes features of the house, features of the community, financial aspects about the house, historical events relevant to the house, a start time for open house, an end time for open house, and other informational messages that may be of interest to a prospective buyer on the tour.

3. The system, as claimed in claim 1, wherein said device has various selectable operating modes, said operating modes comprising: an administrator guide mode, wherein data relevant to one or more houses can be loaded or manipulated and said device can be tailored for an intended user; an explicit tour mode, wherein touch-screens on said device are selected by the intended user, such as a real estate agent or a prospective buyer, to provide information; an implicit tour mode, wherein the motion sensor of said device detects a person entering a house or a room, prompting said device to provide information about the room or house; and a deferentially-explicit tour mode, wherein said device, upon detecting an individual, announces to that individual, that said device is portable and can be carried on the tour to provide information about the house by activating the touch-screens.

4. The system, as claimed in claim 1, wherein said database software application provides screens for keeping track of which houses have been visited, for keeping track of which houses are to be revisited, for making notes about the house, and for leaving confidential comments, questions, or offers on the house.

5. The system, as claimed in claim 2, wherein said script is provided in more than one language.

6. The system, as claimed in claim 1, wherein said script is provided in a readable text format.

7. The system, as claimed in claim 3, wherein the touch-screen, in the explicit tour mode and the deferentially-explicit tour mode, displays a digital image of a house plan, and where by touching the screen at a point in the house plan, actuates the script providing information about that house at that point.

8. The system, as claimed in claim 3, wherein said device processes text messaging, or verbal messaging, or both text and verbal messaging.

9. The system, as claimed in claim 3, wherein said device can process electronic digital signature.

10. The system, as claimed in claim 3, wherein said device processes credit cards.

11. The system, as claimed in claim 3, wherein said device can provide driving instructions and navigational information.

12. The system, as claimed in claim 3, wherein said device has a wireless means for communication over the Internet and the telephone PSTN.

13. The system, as claimed in claim 3, wherein said device is pocket personal computer.

14. The system, as claimed in claim 3, wherein said database software application can store information about a list of houses, and can sort the list on criteria designated by the prospective buyer, where examples of criteria include: ordering by distance from a designated starting point, ordering by size, ordering by cost, ordering by style of house, ordering by age, ordering by features.

15. A method for automating open house tour guides, said method comprising: positioning at an entrance a device that has a proximity/motion sensor that detects the presence of an individual taking the tour, and an audio component; sensing an individual and activating the audio component; delivering a verbal script, wherein the verbal script describes information about the house.

16. A method for automating home tour guides, said method comprising:
providing a portable computerized communication device with a graphic user interface having a touch-screen, a speaker, a digital image of a house plan, and a database software application that contains a script that provides information about the house;
displaying a house plan on the screen; and
touching the screen at a point in the house plan, thereby actuating the script to provide information about that point.

17. The method for automating home tour guides, as claimed in claim 16, said method further comprising:
selecting a list of at least one house, either for a private tour or an open house, and down loading information specific to the house.

18. The method for automating home tour guides, as claimed in claim 17, said method further comprising:
sorting the list by criteria designated by the user, where examples of criteria include: ordering by distance from a designated starting point, ordering by size, ordering by cost, ordering by style of house, ordering by age, ordering by features.

19. The method for automating home tour guides, as claimed in claim 16, said method further comprising:
selecting an operating mode, said operating mode comprising:
an explicit tour mode, wherein touch-screens to provide information on said device are selected by the intended user;
an implicit tour mode, wherein the motion sensor of said device detects an individual entering a house or a room, prompting said device to provide information about the room or house; and
a deferentially-explicit tour mode, wherein said device, upon detecting an individual, announces to that individual, that said device is portable and can be carried on the tour to provide information about the house by activating the touch-screens.

20. The method for automating home tour guides, as claimed in claim 19, said method further comprising:
selecting the implicit tour mode, initiating the activation of the motion sensor, and setting up at least one of the devices in a home or near an entrance of a room that is to be toured during an open-house or a private tour; or
selecting the explicit tour mode, and giving the intended user(s) the device to use while on tour; or
selecting the deferentially-explicit tour mode, initiating the activation of the motion sensor, and setting up the device near the entrance of a home, wherein said device, upon detecting an individual, announces to that individual, that said device is portable and can be carried on the tour to provide information about the house by using the touch-screens

21. The system, as claimed in claim 3, wherein said selectable operating modes further comprises a contract mode, wherein the device is configured to display a contract and accept money.
